(19) United States
(12) Patent Application Publication
(10) Pub. No.: US 2025/0272235 A1
(43) Pub. Date: Aug. 28, 2025

(54) SYSTEM FOR MEMORY-FOCUSED PER-OBJECT TELEMETRY

(71) Applicant: MICRON TECHNOLOGY, INC., Boise, ID (US)

(72) Inventor: David Andrew Roberts, Wellesley, MA (US)

(21) Appl. No.: 19/049,560

(22) Filed: Feb. 10, 2025

Related U.S. Application Data
(60) Provisional application No. 63/558,439, filed on Feb. 27, 2024.

(51) Int. Cl. G06F 12/02

(52) U.S. Cl. CPC G06F 12/0246

(57) ABSTRACT

A log of memory access requests initiated by a computer and directed to a memory device are received from a host system. A memory address map associated with the computer program is received. A memory access request in the log of memory access requests is identified. The identified memory access request is associated with an address. An object of the computer program is identified based on the memory address map. At least a part of the object resides at a memory location referenced by the address. One or more values of respective one or more memory access metrics associated with the object are determined.

### CROSS-REFERENCE TO RELATED APPLICATION(S)

The present application claims priority to U.S. Provisional Patent Application No. 63/558,439, filed on Feb. 27, 2024 and entitled “SYSTEM FOR MEMORY-FOCUSED PER-OBJECT TELEMETRY”, the entire contents of which are hereby incorporated by reference herein.

### TECHNICAL FIELD

Embodiments of the disclosure relate generally to memory sub-systems, and more specifically, relate to a system for memory-focused per-object telemetry.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 illustrates an example memory access request log, an example memory address map, and an example per-object analysis table, in accordance with some embodiments of the present disclosure.

FIG. 3 is a flow diagram of an example method to determine memory access metric values on a per-object basis, in accordance with some embodiments of the present disclosure.

FIG. 4 is a flow diagram of an example method to facilitate memory performance enhancements using memory-side trace telemetry, in accordance with some embodiments of the present disclosure.

FIG. 5 is an example user interface of a memory profiler tool, in accordance with some embodiments of the present disclosure.

FIG. 6 is a block diagram of an example computer system in which embodiments of the present disclosure may operate.

### DETAILED DESCRIPTION

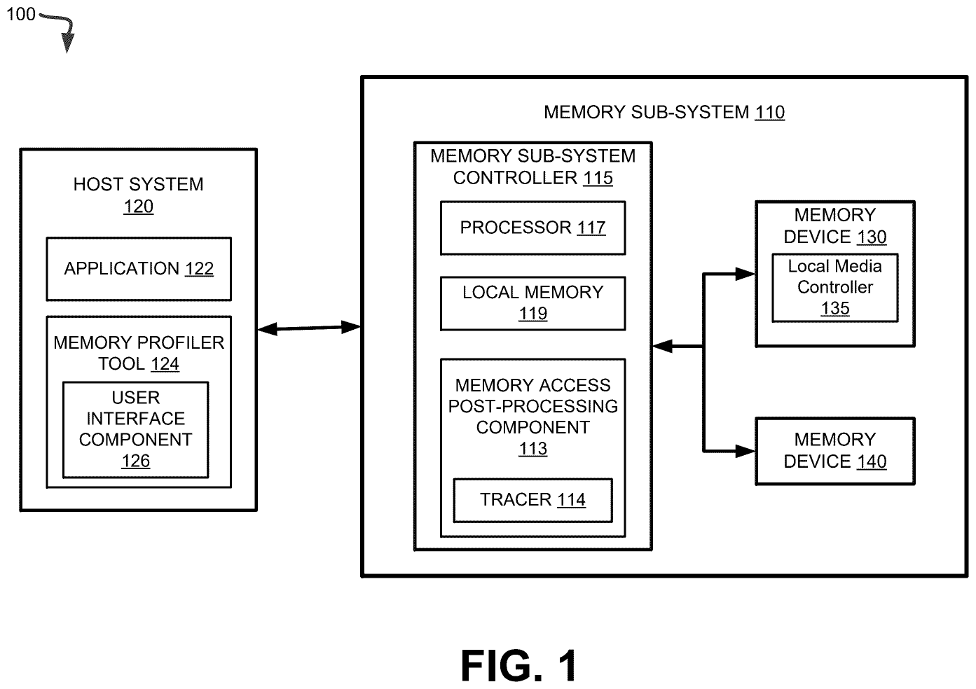

Aspects of the present disclosure are directed to memory-focused per-object telemetry. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not- and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. The memory cells can be formed on a silicon wafer in an array of columns and rows. A wordline can refer to one or more conductive lines coupled to memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

Memory telemetry can be used by the host system and/or by the memory sub-system controller to optimize memory usage. Memory telemetry can include memory access metrics, such as a frequency of access metric (e.g., a memory access count), or a reuse distance metric (e.g., a number of distinct memory accesses made by multiple memory references to the same location in memory). The host system and/or the memory sub-system controller can use memory access metrics to implement a variety of optimization mechanisms, such as to optimize page scheduling (e.g., to guide data placement by relocating heavily access pages to faster memory devices to improve performance), to optimize memory usage by applications running on the host system, to optimize virtual machine provisioning, to optimize security monitoring among other applications, etc. Memory telemetry can also be used for memory management, such as to decide what size of on-chip cache or off-chip (e.g., DRAM) page cache should be used. For example, using memory telemetry, the host system and/or the memory sub-system controller can sort the moveable memory segments in order of access frequency or access count. The host system and/or the memory sub-system controller can periodically reorganize the moveable memory segments so that the most frequently accessed segments are placed in the fastest memory type. The segments that are less frequently accessed can be placed in a slower memory device that is generally higher capacity and less expensive.

Memory semantic protocols, such as compute express link (CXL), Gen-Z, or RapidIO, enable telemetry-capable memory sub-systems to determine, monitor, and/or process memory access metrics (i.e., memory telemetry). That is, telemetry-capable memory sub-systems can use CXL, Gen-Z and/or RapidIO protocols to enable telemetry capabilities. However, these telemetry-capable memory sub-systems are limited to monitoring the memory sub-system and/or individual memory devices, providing a general overview of the memory performance. The memory access metrics for the memory sub-system and/or individual memory devices provide a high-level overview of the performance of the memory sub-system and/or of individual memory devices, but fail to provide insight into the memory performance for memory accessed by a particular application. Thus, conventional memory access metrics lack the capability to provide detailed memory performance metrics specific to an application or computer program. While some applications can sample performance metrics specific to the application, recording and/or measuring performance metrics for every memory request on a host system's central processing unit (CPU) or graphics processing unit (GPU) may cause excessive performance penalties. Moreover, some memory requests generated by the CPU and/or GPU are hidden from user programs or applications (e.g., CPU-or GPU-generated cache prefect read requests sent to memory), and thus recording and/or measuring performance metrics on a host system may result in an incomplete assessment of the memory access requests.

A host system can provide approximate memory performance metrics specific to an application or computer program using simulation-based methods. For example, a compiler can simulate execution of the code to approximate memory request traces, and provide code modifications to optimize the memory access requests before generating the binary file. However, these memory performance metrics are an approximation based on a partial simulation of execution of the source code, which can result in imprecise and/or inaccurate metrics. A host system can perform periodic instruction sampling to determine memory performance metrics. For example, a host system can periodically (e.g., once every few hundred instructions) log a memory request address into a buffer. Memory access metrics can be determined using the addresses in the buffer. However, since not every memory request is logged in the buffer, the memory access metrics can be imprecise and/or inaccurate. Such periodic instruction sampling may adversely affect the performance of the host system. As the frequency of the sampling increases, the performance of the host system may decrease (e.g., the CPU and/or GPU can experience an increase in latency).

Aspects of the present disclosure address the above-noted and other deficiencies by having a memory sub-system that can perform memory sub-system performance analysis on a per-object basis, and provide object-specific memory usage insights into the performance of the memory sub-system. Using a memory address map for a computer program, a memory sub-system controller can correlate memory access requests generated by the computer program with objects of the computer program code. A memory address map represents how memory addresses are allocated. In some embodiments, the memory address map can be generated using the code of the computer program. The source code can include memory allocation requests (e.g., to specific physical addresses of the memory sub-system) corresponding to objects in the code. A memory access request can reference a particular address (or address range) in memory. The memory address map can correlate the address (or address range) with the object that requested access to the address (or address range). In some embodiments, the memory address map can be generated by the host system on which the computer program is running and sent to the memory sub-system controller. In some embodiments, the memory sub-system controller can generate the memory address map by intercepting and/or otherwise identifying memory allocation requests initiated by the computer program.

The memory sub-system controller can perform memory performance analysis on a per-object basis. The memory sub-system controller can use a log of memory access requests initiated by the computer program to perform the performance analysis on a per-object basis. In some embodiments, the log of memory access requests can be generated by a tracer. A tracer tracks (or traces) the execution of a program. In some embodiments, the tracer can run on the host system, and the memory access log generated by the tracer can be sent to the memory sub-system controller. In some embodiments, the tracer can run on the memory sub-system controller. For example, the tracer can be a memory-side CXL protocol logger that is capable of recording any or all fields of memory bus packets into trace buffers. The tracer can log multiple attributes of the memory requests, including the request type (e.g., the command), a timestamp of when the request was executed, addresses accessed by the request (physical addresses, logical addresses, a start and an end address, etc.), and/or any other attribute generated by the request. In some embodiments, the tracer can run continuously and can capture all program activity. In some embodiments, the source code of the computer program can include commands to start and stop the tracer. Thus, the tracer can trace memory telemetry around certain functions within the computer program.

The memory sub-system controller can identify the memory access requests recorded by the tracer according to the corresponding object. That is, the memory sub-system controller can determine the object that corresponds to a memory access request by comparing the address accessed by the request to the memory address map. The memory sub-system controller can identify the object ID in the memory address map corresponding to the memory access request, and calculate per-object memory access metrics using the corresponding memory access requests. The memory access metrics can include, for example, temporal reuse distance, page access heat maps, stream detections, object access bandwidth, object read/write ratio, and/or device-level bank conflicts within the object.

The memory sub-system controller can store the per-object memory access metrics, e.g., in a data structure. In some embodiments, the memory sub-system controller can send the per-object memory access metrics to the host system. In some embodiments, the memory sub-system controller can send (or provide access to) the data structure to the host system. In some embodiments, the memory sub-system controller can determine source code modifications using the per-object memory access metrics. Source code modifications are suggested modifications to the source code of the computer program that may improve the performance of the memory accessed by the computer program. In some embodiments, the memory sub-system controller can compare a per-object memory access metric to a corresponding threshold value. If the per-object memory access metric does not satisfy the corresponding threshold value (e.g., is above or below the value), the memory sub-system controller can identify a corresponding suggested source code modification to optimize the per-object memory access metric.

In some embodiments, the host system can display the per-object memory access metrics in an interactive user interface. In some embodiments, the interactive user interface can include visual source code modifications that are determined using the per-object memory access metrics. In some embodiments, the host system can include a profiler tool that can run in parallel with the program code. The profiler tool can receive the per-object memory access metrics, and can display the per-object memory access metrics in an interactive user interface. As an illustrative example, the user interface can display multiple graphs, each displaying a specific memory access metric (or a combination of specific memory access metrics). A user can interact with the display, e.g., by selecting an address range in the graph, which can cause the user interface to display additional information corresponding to the address range (e.g., the specific object corresponding to the address range, the memory access metrics corresponding to the object, an identified code change hint, etc.). The profiler tool can run in parallel with the program code, or can run after execution of the program code.

In some embodiments, the host system, rather than the memory sub-system controller, can perform the per-object memory analysis and determine the per-object memory access metrics and/or the code change hints. For example, the memory sub-system controller can send the memory access request log generated by the tracer to the host system, and the host system can determine the per-object metrics.

Advantages of the present disclosure include, but are not limited to, determining and providing accurate memory performance analysis for a particular computer program. Conventional host-side instruction sampling or memory tracing telemetry can negatively impact the performance and latency of the execution of a computer program. Using memory-side logging telemetry, as described herein, provides more accurate memory performance analysis while not affecting the performance or latency of the execution the computer program. Aspects of the present disclosure enables performance optimization that are specific to a particular computer program, resulting in an overall improvement to the performance of the execution of the computer program and/or the functioning of the memory sub-system.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a memory access post-processing component 113 that can perform memory performance analysis on a per-object basis. In some embodiments, the memory sub-system controller 115 includes at least a portion of the memory access post-processing component 113. In some embodiments, the memory access post-processing component 113 is part of the host system 120, an application, or an operating system. In other embodiments, local media controller 135 includes at least a portion of memory access post-processing component 113 and is configured to perform the functionality described herein.

The memory access post-processing component 113 and/or the memory profiler tool 124 enable real-time analysis and interactive visualization of the memory performance during the execution of a computer program (e.g., corresponding to application 122).

The memory access post-processing component 113 can receive trace data from a tracer 114. In some embodiments, the tracer 114 can be a memory tracer that traces memory allocations and deallocations. In some embodiments, the tracer 114 can run in the host system 120, and can send the trace data to the memory sub-system controller 115. In some embodiments, the tracer 114 can run in the memory sub-system 110, e.g., as part of the memory access post-processing component 113. In some embodiments, a separate component or processor (not pictured) can run tracer 114. In some embodiments, the memory-side tracer 114 can observe CXL protocol packets to record trace data (e.g., fields of memory bus packets) into a trace buffer. In some embodiments, the trace buffers can be stored in local memory 119.

Trace data can be a log of memory access requests initiated by application 122. Application 122 can be any computer program that is running on host system 120. In some embodiments, application 122 can be a computer program that is running on a separate device connected to host system 120. In some embodiments, the trace data recorded in the log of memory access requests can include the memory access request type, the timestamp that the memory access request was logged by the tracer 114, the address referenced by the memory access request, and any other attribute corresponding to the memory access request.

In some embodiments, the tracer 114 can record memory allocation trace data corresponding to application 122, for the complete duration of the execution of application 122. In some embodiments, the source code of application 122 can include instructions to start and stop the tracer 114 from recording trace data. An instruction to start and/or stop the tracer 114 from recording trace data can be an application programming interface (API) command. Thus, the tracer 114 can record trace data corresponding to certain functions of the application 122.

In some embodiments, the memory access post-processing component 113 can receive a memory address map corresponding to application 122, e.g., from host system 120. In some embodiments, the memory access post-processing component 113 can generate the memory address map corresponding to application 122. The memory address map can represent the allocation of memory addresses. The memory address map can be generated for a specific computer program (e.g., the computer program corresponding to application 122), e.g., from the source code of the specific computer program. The memory address map can store multiple entries, each entry mapping an object of the computer program to a respective address, or range of addresses. In addition, each entry in the memory address map can store a reference to the line of source code that generated the corresponding object of the computer program. As an illustrative example, a line of code in the source code of the computer program corresponding to application 122 can generate an object referencing an address (or an address range including a start address and an end address) in the memory sub-system 110 (e.g., on memory device 130). The memory address map can include an entry that stores the object ID identifying the object (e.g., the object name as specified in the source code), the address (or range of addresses), and/or a reference to the line of the source code that generated the object. In some embodiments, the memory address map can store additional information not listed here.

The memory access post-processing component 113 can use the memory address map to identify portions of a memory device (e.g., memory device 130, 140) that are used to store object data for the application 122. In some embodiments, the memory sub-system controller 115 can initiate a new logical instance (post-processing task) of the memory access post-processing component 113 for each identified object of application 122.

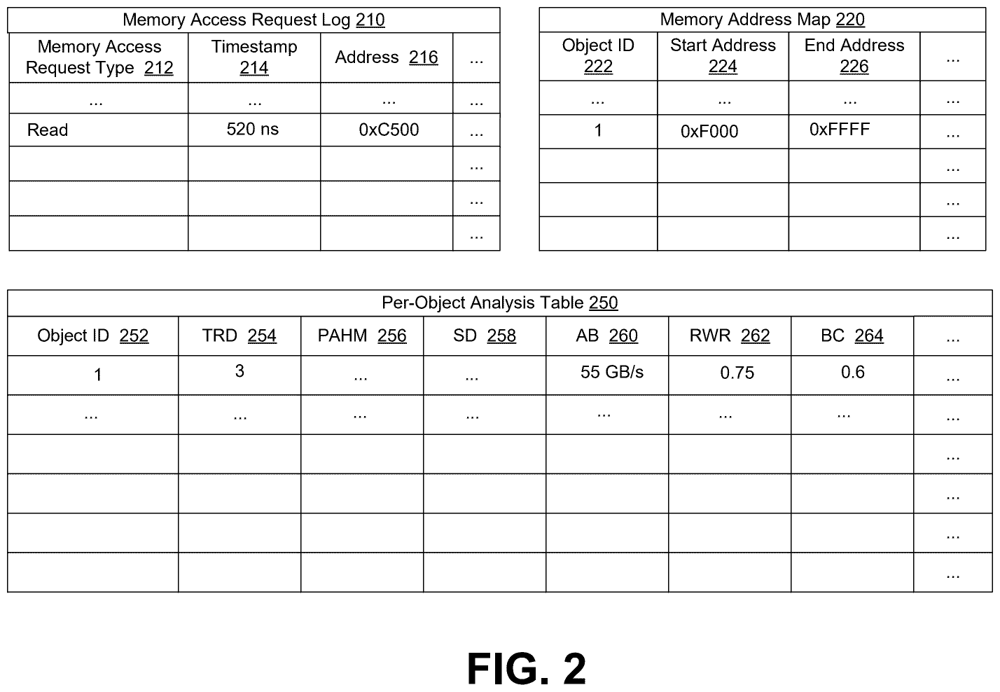

The memory access post-processing component 113 can calculate various memory access performance metrics on a per-object basis. Examples of the per-object memory access performance metrics include a temporal reuse distance metric, a page access heat map metric, an address stream or sequence detection metric, an object access bandwidth metric, an object read/write ratio metric, and/or a bank conflict metric. The memory access performance metrics are further described with respect to FIG. 2.

In some embodiments, the memory access post-processing component 113 runs on an embedded processor in the memory sub-system 110. In some embodiments, the memory access post-processing component 113 can be hardware accelerated. That is, embedded processor running the memory access post-processing component 113 can have hardware accelerated I/O paths that enable the trace data, and/or the memory allocation and/or memory access (e.g., input/output commands) requests, to be communicated directly between the host system 120 and the embedded process, bypassing the firmware of the memory sub-system 110. In some embodiments, the memory access post-processing component 113 can run on host system 120.

In some embodiments, the memory access post-processing component 113 can send the per-object memory access performance metrics to a memory profiler tool 124 of host system 120. The memory profiler tool 124 provides memory-side trace telemetry, and analyzes and monitors the memory consumption of application 122. In some embodiments, the memory profiler tool 124 can analyze the per-object memory access performance metrics to identify source code modifications that may optimize the memory usage performance of the application 122. In some embodiments, the memory access post-processing component 113 can identify and send the source code modifications to the memory profiler tool 124.

In some embodiments, to identify source code modifications, the profiler tool 124 can compare values of the per-object memory access performance metrics to corresponding threshold values. The threshold values can have associated source code modification suggestions. Thus, if one of the per-object memory access performance metrics does not satisfy the threshold value (e.g., falls below or is greater than the corresponding threshold value), the memory profiler tool 124 can identify a corresponding source code modification to improve the metric. In some embodiments, the threshold values and corresponding source code modifications can be stored in a table.

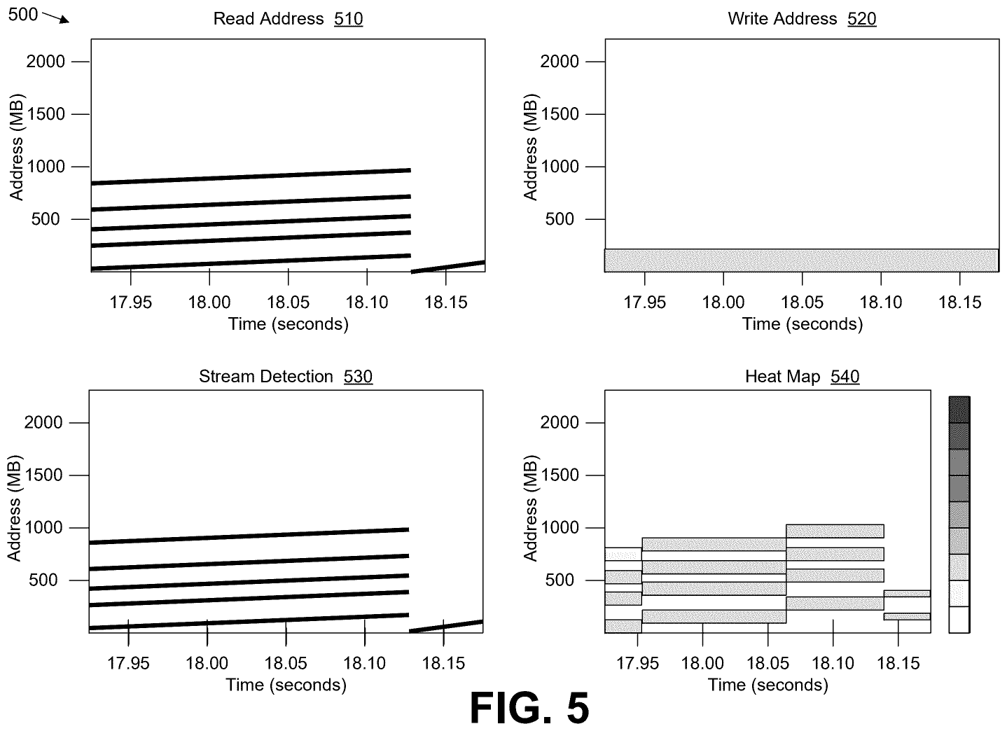

User interface component 126 of memory profiler tool 124 can display the per-object memory access performance metric value(s) and/or the identified source code modifications in an interactive user interface. An example of the user interface is described with respect to FIG. 5. In some embodiments, the user interface component 126 can generate graphs corresponding to some (or all) of the per-object memory access performance metrics for an application 122. The graphs can display the metric values over time (e.g., bandwidth over time, heat map over time, etc.). The user interface component 126 can enable a user to select a memory page or object of interest (e.g., an object that is displayed as highly accessed, or “hot,” in the heat map). In response to a user selecting an object of interest, the user interface component 126 can display additional data corresponding to the selected object. The additional data can include, for example, other per-object memory access performance metric values. In some embodiments, the addition data can include the specific line of code that allocated the object, the read/write access as compared to other objects (e.g., the selected object is ten times more heavily read than other objects), the CXL command type that accessed the address corresponding to the object, other times in the execution timeline of the application 122 that the object was accessed, the size of cache needed to capture the object, etc. In some embodiments, the additional data can include the source code modification, such as a recommendation to insert a software prefetch instruction at a specific place in the code corresponding to the address stride stream metric.

Further details with regards to the operations of the memory access post-processing component 113 are described below.

FIG. 2 illustrates example memory access request log 210, memory address map 220, and per-object analysis table 250, in accordance with some embodiments of the present disclosure.

In some embodiments, the memory access request log 210 is generated by tracer (e.g., tracer 114 of FIG. 1). The memory access request log 210 can store, for each memory access request, a corresponding memory access request type 212 (e.g., a read request, a write request, etc.), a timestamp 214 (e.g., at 520 nanoseconds), and address 216, and/or any other attribute corresponding to a memory access request initiated by an computer program (e.g., application 122 of FIG. 1).

In some embodiments, the memory address map 220 can be received by the memory access post-processing component 113 from the host system 120. In some embodiments, the memory address map 220 can be generated by the memory access post-processing component 113, e.g., from memory allocation requests to physical addresses initiated by a computer program (e.g., application 122 of FIG. 1). The memory allocation requests in the source code of the computer program can specify the object from which the allocation request originated, as well as the start address and end address allocated to the object. The memory address map 220 can store, for each object, a corresponding object identifier 222 identifying the object from which the memory allocation request originated, the start address 224 of the memory allocation request, the end address 226 of the memory allocation request, and/or any other fields corresponding to the memory allocation request corresponding to the object. In some embodiments, the object ID 222 can be the name of the object, as specified in the source code. In some embodiments, the object ID 222 can be a generated unique identifier for the object (e.g., generated by the host system 120 or by the memory access post-processing component 113). In some embodiments, the memory address map 220 can store a single address (e.g., the start address 224), as specified in the memory allocation request. In some embodiments, the start address 224 and/or the end address 226 can reference a logical address of the memory sub-system 110 (e.g., referencing memory device 130, 140). In some embodiments, the start address 224 and/or the end address 226 can reference a physical address of the memory sub-system 110 (e.g., referencing memory device 130, 140).

In some embodiments, the per-object analysis table 250 can be generated by the memory access post-processing component 113. The per-object analysis table 250 can store the per-object memory performance metrics determined by the memory access post-processing component 113.

The memory access post-processing component 113 can identify a memory access request from the memory access request log 210. In some embodiments, the memory access post-processing component 113 can identify the memory access requests in sequential order, as they are stored in the memory access request log 210. For example, the memory access post-processing component 113 can identify the first memory access request in the memory access request log 210, perform the per-object analysis on that memory access request, and then identify the second memory access request in the memory access request log 210 and perform the per-object analysis on the second memory access request, and so on. In some embodiments, the memory access request log 210 can be sorted by address, timestamp, or another field in the memory access request log 210, and the memory access post-processing component 113 can identify a memory access request from the memory access request log 210 based on the sorting. In some embodiments, a new logical instance of the memory access post-processing component 113 can be initiated for each object in the memory address map 220, and the memory access post-processing component 113 can generate and/or update the per-object analysis table 250 for each memory access request corresponding to the object. For example, as memory requests are traced by tracer 114, the memory access post-processing component 113 can multi-task and switch to a logical instance of the memory access post-processing component 113 that corresponds to the address (e.g., address 216) of the newly traced memory request.

The memory access post-processing component 113 can perform memory performance analysis for the identified memory access request(s). The memory access post-processing component 113 can identify the object (e.g., the object ID 222 in memory address map 220) corresponding to the identified memory access request using the memory address map 220. In some embodiments, the memory access post-processing component 113 can compare the address referenced by the memory access request (e.g., address 216 in memory access request log 210) to the address(es) in the memory address map 220 (e.g., address(es) 224-226) to identify the object ID.

In some embodiments, the memory access post-processing component 113 can create a record for each object ID 252 identified in the memory address map 220. In some embodiments, each record in the per-object analysis table 250 can represent a larger data structure. Thus, each entry can consist of a valid flag indicating the validity of the record, and a pointer to reserved memory space that stores the larger data structure. For each object ID 252, the memory access post-processing component 113 can generate and store multiple metrics, such as the temporal reuse distance (TRD) 254, the page access heat map (PAHM) 256, the stream detection (SD) 258, the object access bandwidth (AB) 260, the object read/write ratio (RWR) 262, and/or the device-level bank conflicts within the object (BC) 264. In some embodiments, the memory access post-processing component 113 can generate and store other metrics not shown in the per-object analysis table 250.

The temporal reuse distance metric 254 represents the number of requests to different memory addresses between successive requests to the same memory address. That is, the temporal reuse metric 254 represents the number of intervening requests to different addresses, between requests to the same memory address. This information can be used to estimate how well the data stored at the memory address would cache. That is, if the temporal reuse distance metric 254 indicates that the number of intervening requests between requests to the same memory address is below a threshold value, the memory access post-processing component 113 can determine to cache the data stored at the memory address. On the other hand, if the temporal reuse distance metric 254 indicates that the time between requests to the same memory address is above a threshold value, the memory access post-processing component 113 can determine not to cache the data stored at the memory address.

In some embodiments, the memory access post-processing component 113 can determine the temporal reuse distance metric 254 by comparing the addresses of successive requests to the same memory address. That is, the memory access post-processing component 113 can address 214 of a memory access request in memory access request lost 210 directed to address 216 corresponding to object ID 252 to the most recent prior occurrence 214 of the request directed to address 215 corresponding to the same object ID 252. In some embodiments, the memory access post-processing component 113 can determine the temporal reuse distance metric 254 by counting the number of requests to different memory address between successive requests to the same memory address. That is, the memory access post-processing component 113 can count the number of memory requests in memory access request log 210 to different memory addresses between successive memory requests to an address 216 corresponding to a particular object identified by object ID 252. In some embodiments, the temporal reuse metric 254 can store an average of the number of requests to difference memory addresses between successive requests to the same memory address (or an average of the time difference between successive requests to the same memory address), taken over a specific timeframe of the execution of the computer program (e.g., of application 122). In some embodiments, the average can be taken over the entire execution timeframe of the computer program. In some embodiments, the average can be taken over a timeframe corresponding to the source code instructions that start and stop the tracer. In some embodiments, the average can be taken over the most recent x number of memory requests to the same memory address (where x is an integer greater than 1), e.g., stored in memory access request lost 210.

The memory access post-processing component 113 can analyze multiple entries in the memory access request log 210, each directed to the same object ID 222, to determine the temporal reuse distance metric 254. In some embodiments, the memory access post-processing component 113 can then use the temporal reuse distance metric 254 to identify recommended source code modifications. For example, in response to determining that the temporal reuse distance metric 254 satisfies a condition (e.g., is below a threshold value, or is greater than or equal to a threshold value), the memory access post-processing component 113 can identify a source code modification corresponding to the threshold value (e.g., a source code modification to cache the data stored at the memory address). In some embodiments, the memory access post-processing component 113 can use the temporal reuse distance metrics 254 to determine whether to cache the data stored at the memory address, without identifying a source code modification. In some embodiments, the memory profiler tool 124 can recommend inserting an instruction in the source code to cache or not cache object data, corresponding to the temporal reuse distance metric 254 value.

The page access heat map metric 256 counts access frequency for movable blocks of data. In some embodiments, the memory access post-processing component 113 can count the number of accesses (e.g., read and/or write commands) stored in memory access request log 210 referencing the object identified by object ID 252. The page access heat map metric 256 stores the number of accesses counted by the memory access post-processing component 113. In some embodiments, the page access heat map 256 metric can store the number of accesses counter by the memory access post-processing component 113 over a specified period of time (e.g., over the last few seconds, over the entire duration of the execution of the computer program, over a timeframe corresponding to the source code instructions that start and stop the tracer, or over another timeframe). In some embodiments, the per-object analysis table 250 can include separate counts for read accesses and for write accesses. This information can be used to determine where to store data. That is, objects that are accessed more frequently (e.g., the access count is above a threshold, or data corresponding to object(s) with the highest access count(s)) can be moved to the faster memory type(s), while objects that are accessed less frequently (e.g., the access count is below a threshold, or the data corresponding to object(s) with the lowest access count(s)) can be moved to the slower memory type(s). In some embodiments, the memory profiler tool 124 can recommend inserting an instruction in the source code to more frequently accessed data on faster memory type, and less frequently accessed data on slower memory type. In some embodiments, the PAHM 256 can be a list of page numbers and the corresponding access count to the last page in the object. An example entry for PAHM 256 can be the following list: (0, 31), (1, 25), . . . (N1, CN1), where Ni is page number i and Ci-1 is the access count to the corresponding page in the object.

The stream detection metric 258 indicates whether a future address request is predictable (what that address will be, and when it will be needed). In some embodiments, the memory access post-processing component 113 can measure and/or store a history of previously accessed memory address sequences, and a trained predictor model (such as a deep neural network). In some embodiments, SD 258 can store and/or reference a list of differences (deltas) between observed addresses in the object. The memory access post-processing component 113 can analyze (e.g., using the trained predictor model) the previously accessed memory address sequences to identify a pattern or sequence of addresses in the requests for a particular object. In some embodiments, the memory access post-processing component 113 can analyze the memory request log 210 to identify a pattern or sequence of addresses in the requests for a particular object. In some embodiments, the memory access post-processing component 113 can determine address pattern matching using prefetch algorithms, such as sequitur, stride prefetch, and/or an artificial intelligence deep neural network prefetcher. In some embodiments, as more memory requests are traced (e.g., by tracer 114), the memory access post-processing component 113 can update the prefect algorithms and/or predictor model(s). The memory access post-processing component 113 can identify the address stream stride from the memory access request log 210. In some embodiments, the memory access post-processing component 113 can store an indicator in stream detection metric 258 indicating that a stream stride has been identified (e.g., that a future address request is predictable), which can cause the memory profiler tool 124 to recommend inserting of software prefetch instructions at a specific place in the source code of application 122.

The object access bandwidth metric 260 indicates the demand level for a particular object (e.g., 55 gigabytes per second). In some embodiments, the memory access post-processing component 113 can maintain a running sum of how many bytes of data are requested for the corresponding object. The object access bandwidth metric 260 can store the number of bytes per second that were requested within that object's address range, over a period of time. The memory access post-processing component 113 can use a counter to count the bytes of data requested, and can periodically reset the counter. The count at reset time can be used to update a moving average of the object access bandwidth metric 260. For example, if the reset interval is the sampling time T, the object access bandwidth metric 260 is represented as the count divided by the sampling time T.

The memory access post-processing component 113 can use the object access bandwidth metric 260 to identify a memory device that has adequate available bandwidth that satisfies the object access bandwidth metric 260 value for the object. In some embodiments, the memory access post-processing component 113 can use the object access bandwidth metric 260 to reduce the power consumption of a particular memory device. For example, for a memory device that has a high power consumption, the memory access post-processing component 113 can identify an object to move to a different device using the object access bandwidth metric 260 value. In some embodiments, the memory profiler tool 124 can recommend inserting an instruction in the source code to move the object data to a memory device corresponding to the object access bandwidth metric 260 value.

The object read/write ratio metric 262 keeps track of the read/write ratio for the object. In some embodiments, the memory access post-processing component 113 can keep count (e.g., using a counter) of the number of read access requests in memory access request log 210 referencing an address 216 correspond to the object data identified by object ID 252, and the number of write access requests in memory access request log 210 referencing an address 216 corresponding to the object data identified by object ID 252. The memory access post-processing component 113 can then determine the read/write ratio metric 262 for the object identified by object ID 252 using the number of read accesses compared to the number of the write accesses. In some embodiments, the memory access post-processing component 113 can keep count of the number read and write accesses for the entire duration of the execution of the computer program (e.g., application 122), for a specified amount of time (e.g., the last 3 seconds), for a timeframe corresponding to the source code instructions that start and stop the tracer, or for another time duration.

As some memory types perform read operations faster than write operations, the memory access post-processing component 113 can use the object read/write ratio metric 262 to place more read-heavy objects on non-volatile memory, and place more write-heavy objects on volatile memory (e.g., DRAM). Thus, the memory access post-processing component 113 can identify an object to move to a different device using the object read/write ratio metric 262 value. In some embodiments, the memory profiler tool 124 can recommend inserting an instruction in the source code to move the object data to a memory type corresponding to the object read/write ratio metric 262 value.

The device-level bank conflicts metric 264 reflects a level of bank conflicts the accesses to the particular object may cause. Shared memory can be divided into segments called banks. Banks designated as open can be accessed. Banks can be further divided into rows, and rows that are activated can be accessed. A bank conflict occurs when a memory request is directed to a row that is not activated in an open bank, thus requiring the new row to be activated. Row activation is time consuming and resource intensive. Thus, bank conflicts can lead to increased latency and reduced overall performance of the memory device and/or memory sub-system. The device-level bank conflicts metric 264 can represent the “row buffer hit rate,” or the number of requests on average directed to open rows. If the device-level bank conflicts metric 264 reflects a high level of bank conflicts, the memory access post-processing component 113 can identify a memory device that suffers a low penalty from bank conflicts on which to store the data corresponding to the object. For example, the device-level bank conflicts metric 264 can reflect a high level of bank conflicts if the row buffer hit rate is below a threshold value. In some embodiments, the memory profiler tool 124 can recommend inserting an instruction in the source code to store the object data to a memory type corresponding to the device-level bank conflict metric 264 value.

In some embodiments, the memory access post-processing component 113 can determine recommended code modifications using the values of the per-object analysis metrics 252-262. In some embodiments, the memory profiler tool 124 can determine recommended code modifications using the values of the per-object analysis metrics 252-262. The recommended code changes can correspond to threshold values for each per-object analysis metric 252-262. Thus, if a per-object analysis metric 252-262 falls above or below a threshold value, the memory access post-processing component 113 and/or the memory profiler tool 124 can identify a corresponding recommended source code modification to optimize the per-object analysis metric 252-262.

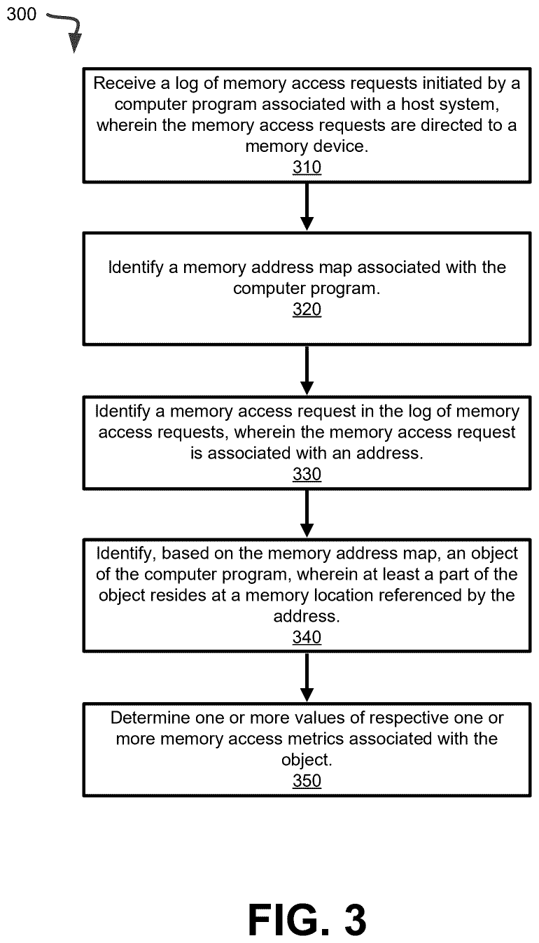

FIG. 3 is a flow diagram of an example method 300 to determine the memory access metric values on a per-object basis, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the memory access post-processing component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic receives a log of memory access requests (e.g., memory access request log 210 of FIG. 2) initiated by a computer program (e.g., application 122 of FIG. 1) and directed to a memory device (e.g., memory device 130 of FIG. 1). In some embodiments, the processing logic receives the log of memory access requests from the host system (e.g., host system 120 of FIG. 1). In some embodiments, the processing logic receives the log of memory access requests from a memory tracer, e.g., tracer 114 of FIG. 1. In some embodiments, the log of memory access requests can include multiple entries. An entry can store at least a request type of the corresponding memory request, a timestamp of the corresponding memory request, or the address that the memory request is referencing.

At operation 320, the processing logic identifies a memory address map (e.g., memory address map 220 of FIG. 2) associated with the computer program (e.g., application 122 of FIG. 1). In some embodiments, the processing logic can receive the memory address map from the host system (e.g., host system 120 of FIG. 1). In some embodiments, the processing logic can generate the memory address map. The processing logic can identify the line of source code that allocated the object, and can identify the object ID from the source code (e.g., the object ID can be the object name). In some embodiments, the processing logic can generate an object ID for each new object identified in the source code. In some embodiments, the processing logic can receive, from the host system, an object identifier identifying the object of the computer program. The processing logic can identify a start address and an end address allocated to the object (e.g., from the source code, or from the host system 120). In some embodiments, the start address and end address can be physical addresses of memory at which the object is stored. In some embodiments, the start address and end address can be logical addresses referencing memory at which the object is stored. The processing logic can then generate a memory address map, or can generate a new record in the memory address map, to include the received object identifier and the corresponding addresses. In some embodiments, the memory address map can include multiple records. A record can store at least an object identifier and a start address. The object identifier can identify the object of the computer program identified at operation 340, and the address associated with the memory request identified at operation 330 can correspond to the start address stored in the record.

At operation 330, the processing logic identifies a memory access request in the log of memory access requests. The identified memory access request is associated with an address. That is, the identified memory access request references an address in the memory sub-system 110 to which the memory access request is directed.

At operation 340, the processing logic identifies, based on the memory address map, an object of the computer program. At least a part of the object resides at a memory location referenced by the address. In some embodiments, the processing logic identifies an object in the memory address map in a sequential order (e.g., starting at the top of the memory address map).

At operation 350, the processing logic determines one or more values of respective one or more memory access metrics associated with the object. Examples of the memory access metrics can include a temporal reuse distance, a page access heat map, a stream detection, an object access bandwidth, an object read-write ratio, or a memory device level bank conflict associated with the object. The memory access metrics are further described with respect to FIG. 2.

In some embodiments, the processing logic stores, in an object analysis data structure (e.g., per-object analysis table 250 of FIG. 2), the one or more values of the respective one or more memory access metrics associated with the object. In some embodiments, the processing logic sends, to the host system, the one or more values of the respective one or more memory access metrics associated with the object.

In some embodiments, the processing logic compares the one or more values of the respective one or more memory access metrics to corresponding threshold values. In response to determining that one of the one or more values fails to satisfy the corresponding threshold value (e.g., exceeds or falls below the corresponding threshold value), the processing logic identifies a recommended code modification to the computer program. The code modification provides an improvement to the performance of the memory sub-system.

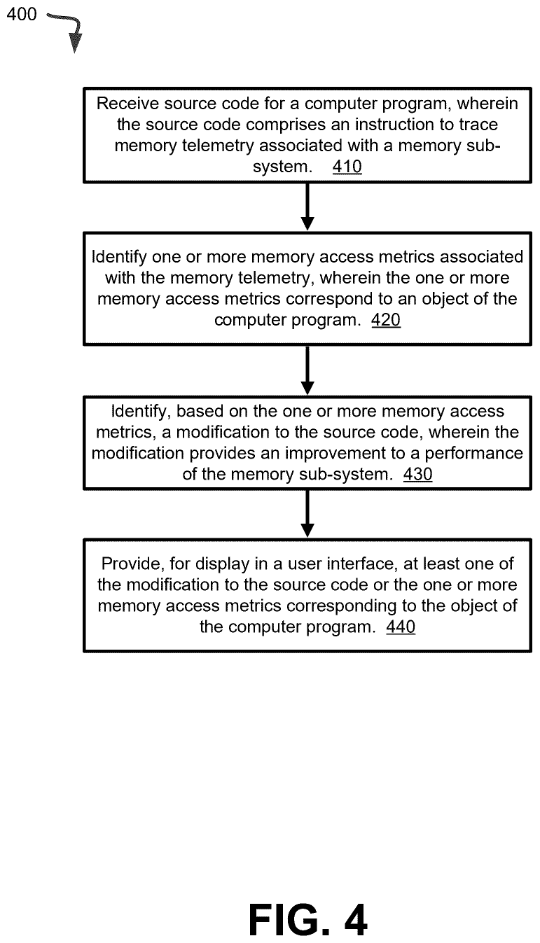

FIG. 4 is a flow diagram of an example method 400 to facilitate memory performance enhancements using memory-side trace telemetry, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the memory access post-processing component 113 of FIG. 1. In some embodiments, the method 400 is performed by the memory profiler tool 124 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic receives source code for a computer program. The source code can include an instruction to trace memory telemetry associated with a memory sub-system (e.g., memory sub-system 110 of FIG. 1).

In some embodiments, the instruction to trace memory telemetry can correspond to a function in the source code. In response to identifying a call to the function in the source code, the processing logic sends a first command to the memory sub-system to initiate a tracer (e.g., tracer 114 of FIG. 1) to trace the memory telemetry. In response to identifying a return from the function in the source code, the processing logic sends a second command to the memory sub-system to stop the tracer.

At operation 420, the processing logic identifies one or more memory access metrics associated with the memory telemetry. The one or more memory access metrics correspond to an object of the computer program. Examples of the memory access metrics can include a temporal reuse distance, a page access heat map, a stream detection, an object access bandwidth, an object read-write ratio, or a memory device level bank conflict associated with the object. The memory access metrics are further described with respect to FIG. 2.

In some embodiments, the processing logic identifies a memory access request in a log of memory access requests (e.g., memory access request log 210 of FIG. 2) initiated by the computer program (e.g., application 122 of FIG. 1) and directed to the memory sub-system (e.g., memory sub-system 110 of FIG. 1). The processing logic identifies, based on a memory address map (e.g., memory address map 220 of FIG. 2) associated with the computer program, the object of the computer program. For example, the processing logic compares the address in the memory access request log to the address stored in the memory address map to identify the object of the computer program. The processing logic determines one or more values of the respective one or more memory access metrics associated with the object.

In some embodiments, the memory address map can include multiple records. A record can store at least an object identifier and a start address. The object identifier can identify the object of the computer program, a start address and an end address.

At operation 430, the processing logic identifies, based on the one or more memory access metrics, a modification to the source code. The modification can provide an improvement to the performance of the memory sub-system. In some embodiments, the processing logic compares the one or more memory access metrics to corresponding threshold values. In response to determining that one of the memory access metrics fails to satisfy the corresponding threshold value (e.g., exceeds or falls below the corresponding threshold value), the processing logic identifies the modification to the source code corresponding to the threshold value.

At operation 440, the processing logic provides, for display in a user interface, at least one of the modifications to the source code or the one or more memory access metrics corresponding to the object of the computer program. The user interface is further described with respect to FIG. 5.

FIG. 5 illustrates an example user interface of a memory profiler tool 124 for displaying per-object memory access metrics, in accordance with some embodiments of the present disclosure. In some embodiments, the example user interface 500 can be generated and/or displayed by user interface component 126 of the memory profiler tool 124 of FIG. 1.

In some embodiments, the user interface can display one or multiple graphs, such as read address 510, write address 520, stream detection 530, and/or heat map 540. Note that the user interface can display more or fewer graphs than those illustrated in FIG. 5. For example, the user interface can display graphs corresponding to each memory access metric as discussed throughout the present disclosure, and/or can display graphs that consolidate multiple memory access metrics discussed throughout the present disclosure. In some embodiments, the user interface of the memory profiler tool can display a time window on the x-axis, and various views into the memory activity of a memory device (e.g., memory device 130, 140) and/or of a memory sub-system as a whole (e.g., memory sub-system 110).

Read address 510 illustrates the read access requests referencing the address(es) on the y-axis over time on the x-axis. Write address 520 illustrates the write access requests referencing the address(es) on the y-axis over time on the x-axis. Heat map 540 illustrates the access frequency of data (e.g., either read or write) referencing the address(es) on the y-axis over time on the x-axis. The data displayed in these graphs can be identified from the page access heat map metric 256 in the per-object analysis table 250. The memory profiler tool 124 can consolidate the data from multiple per-object analysis tables 250 corresponding to a computer program (e.g., application 122). That is, since the memory access post-processing component 113 can generate and/or maintain a per-object analysis table 250 for each object in the computer program, the memory profiler tool 124 can consolidate the data from each per-object analysis table 250 and display the consolidated data in the user interface 500.

Stream detection 530 can display the stream of the data requests from the memory access request log 210 over time on the x-axis. The memory profiler tool 124 can determine address pattern matching, e.g., using prefetch algorithms, and can provide a recommendation to insert software prefetch instructions at a particular place in the source corresponding to the detected streams.

The user interface component 126 of memory profiler tool 124 can enable a user to interact with the user interface 500. A user can scroll to different points in time in each of the displayed graphs 510-540, to view the memory access metrics over time. In some embodiments, a user can hover a particular point on a graph 510-540, and the user interface 500 can display additional information corresponding to that point on the graph 510-540. The additional information can include, for example, the specific object ID referencing the address at that point in time, the other metrics corresponding to that specific object (e.g., as stored in per-object analysis table 250), and/or identified code modifications pertaining to the specific object. The additional information can be displayed in a pop-up window, for example.

In some embodiments, the memory profiler tool 124 can run in parallel with the application 122, and the graphs 510-540 can update in near real-time. In some embodiments, the memory profiler tool 124 can display the graphs 510-540 after execution of the application 122, displaying previously captured data stored in the per-object analysis table(s) 250 corresponding to the application 122. The user interface component 126 can enable a user to pause the display of graphs 510-540 at a particular point in time, as well as scroll back in time and move forward in time, to view the memory access analysis over time.

In some embodiments, the user interface component 126 of memory profiler tool 124 can enable a user to select a recommended code modification. In response to receiving the selection, the memory profiler tool 124 can cause the application 122 to invoke the selected code modification by making the modification in the source code corresponding to the application 122. The memory profiler tool 124 can cause the modified source code to run, and can display the updated memory access performance metrics in user interface 500. In some embodiments, the user interface component 126 of memory profiler tool 124 can highlight the changes to the updated memory access performance metrics corresponding to the selected source code modification, thus enabling a user to visualize the change in memory performance as a result of the modified source code. In some embodiments, the user interface component 126 can display two sets of graphs 510-540; the first set is related to the previously run source code and the previously displayed memory access performance metrics, and the second set of graphs 510-540 can display the updated displayed memory access performance metrics corresponding to the execution of the modified source code.

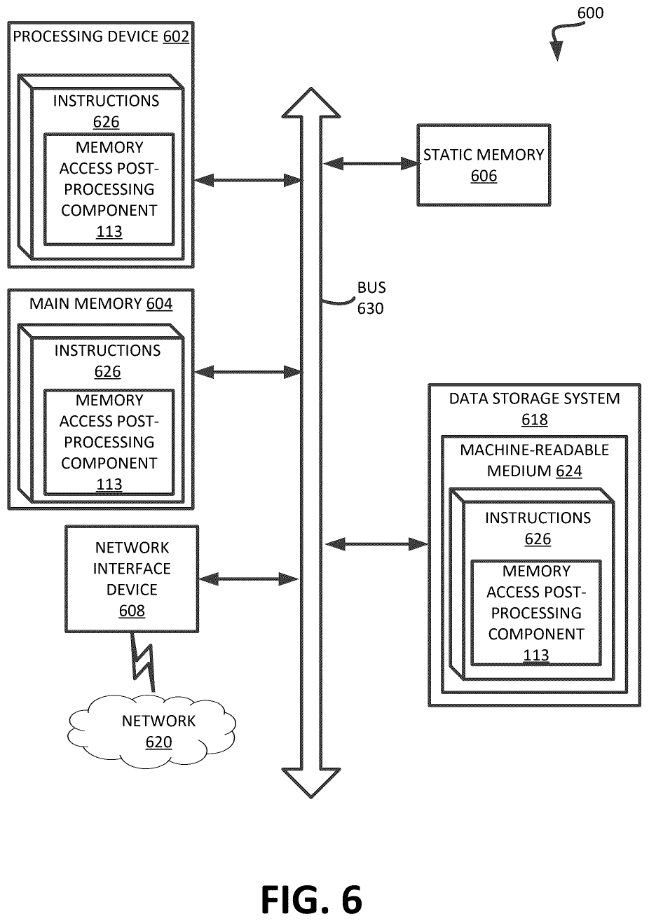

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the memory access post-processing component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a memory access post-processing component (e.g., the memory access post-processing component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
receiving a log of memory access requests initiated by a computer program associated with a host system, wherein the memory access requests are directed to the memory device;
identifying a memory address map associated with the computer program;
identifying a memory access request in the log of memory access requests, wherein the memory access request is associated with an address;
identifying, based on the memory address map, an object of the computer program, wherein at least a part of the object resides at a memory location referenced by the address; and
determining one or more values of respective one or more memory access metrics associated with the object.

2. The system of claim 1, wherein the operations further comprise:
storing, in an object analysis data structure, the one or more values of the respective one or more memory access metrics associated with the object.

3. The system of claim 1, wherein the operations further comprise:
sending, to the host system, the one or more values of the respective one or more memory access metrics associated with the object.

4. The system of claim 1, further comprising:
receiving, from the host system, an object identifier identifying the object of the computer program;
identifying a start address and an end address associated with the object; and
generating the memory address map, wherein the memory address map comprises a plurality of records, wherein a record of the plurality of records comprises the object identifier, the start address and the end address, and wherein the address corresponds to at least one of the start address or the end address.

5. The system of claim 1, wherein the one or more memory access metrics comprise a temporal reuse distance, a page access heat map, a stream detection, an object access bandwidth, an object read-write ratio, or a memory device level bank conflict associated with the object.

6. The system of claim 1, wherein the log of memory access requests comprises a plurality of entries, wherein an entry of the plurality of entries comprises at least a request type associated with the memory access request, a timestamp associated with the memory access request, and the address associated with the memory access request.

7. The system of claim 1, wherein the operations further comprise:
responsive to determining that one of the one or more values of the respective one or more memory access metrics exceeds a threshold value, identifying a recommended code modification to improve a performance of the system.

8. A non-transitory computer-readable storage medium comprising instructions that, when executed by a processing device, cause the processing device to perform operations comprising:
receiving source code for a computer program, wherein the source code comprises an instruction to trace memory telemetry associated with a memory sub-system;
identifying one or more memory access metrics associated with the memory telemetry, wherein the one or more memory access metrics correspond to an object of the computer program;
identifying, based on the one or more memory access metrics, a modification to the source code, wherein the modification provides an improvement to a performance of the memory sub-system; and
providing, for display in a user interface, at least one of the modifications to the source code or the one or more memory access metrics corresponding to the object of the computer program.

9. The non-transitory computer-readable storage medium of claim 8, wherein the one or more memory access metrics comprise a temporal reuse distance, a page access heat map, a stream detection, an object access bandwidth, an object read-write ratio, or a memory device level bank conflict associated with the object.

10. The non-transitory computer-readable storage medium of claim 8, wherein the instruction to trace memory telemetry corresponds to a function in the source code, and wherein the processing device is to perform operations further comprising:
responsive to identifying a call to the function in the source code, sending a first command to the memory sub-system to initiate a tracer to trace the memory telemetry; and
responsive to identifying a return from the function in the source code, sending a second command to the memory sub-system to stop the tracer.

11. The non-transitory computer-readable storage medium of claim 8, wherein identifying, based on the one or more memory access metrics, the modification to the source code comprises:
responsive to determining that a value of one of the one or more memory access metrics exceeds a threshold value, identifying the modification to the source code corresponding to the threshold value.

12. The non-transitory computer-readable storage medium of claim 8, wherein the processing device is to perform operations further comprising:
identifying a memory access request in a log of memory access requests initiated by the computer program and directed to the memory sub-system;
identifying, based on a memory address map associated with the computer program, the object of the computer program; and
determining one or more values of the respective one or more memory access metrics associated with the object.

13. The non-transitory computer-readable storage medium of claim 12, wherein the memory address map comprises a plurality of records, wherein a record of the plurality of records comprises an object identifier identifying the object, a start address and an end address.

14. A method comprising:
receiving a log of memory access requests initiated by a computer program associated with a host system, wherein the memory access requests are directed to a memory device of a memory sub-system;
identifying a memory address map associated with the computer program;
identifying a memory access request in the log of memory access requests, wherein the memory access request is associated with an address;
identifying, based on the memory address map, an object of the computer program, wherein at least a part of the object resides at a memory location referenced by the address; and
determining one or more values of respective one or more memory access metrics associated with the object.

15. The method of claim 14, further comprising:
storing, in an object analysis data structure, the one or more values of the respective one or more memory access metrics associated with the object.

16. The method of claim 14, further comprising:
sending, to the host system, the one or more values of the respective one or more memory access metrics associated with the object.

17. The method of claim 14, further comprising:
receiving, from the host system, an object identifier identifying the object of the computer program;
identifying a start address and an end address associated with the object; and
generating the memory address map, wherein the memory address map comprises a plurality of records, wherein a record of the plurality of records comprises the object identifier, the start address and the end address, and wherein the address corresponds to at least one of the start address or the end address.

18. The method of claim 14, wherein the one or more memory access metrics comprise a temporal reuse distance, a page access heat map, a stream detection, an object access bandwidth, an object read-write ratio, or a memory device level bank conflict associated with the object.

19. The method of claim 14, wherein the log of memory access requests comprises a plurality of entries, wherein an entry of the plurality of entries comprises at least a request type associated with the memory access request, a timestamp associated with the memory access request, and the address associated with the memory access request.

20. The method of claim 14, further comprising:
responsive to determining that one of the one or more values of the respective one or more memory access metrics exceeds a threshold value, identifying a recommended code modification to improve a performance of the memory sub-system.
